(19) United States
(12) Patent Application Publication
(10) Pub. No.: US 2016/0246472 A1
(43) Pub. Date: Aug. 25, 2016

(54) AUTHENTICATION BASED ON A TAP SEQUENCE PERFORMED ON A TOUCH SCREEN

(71) Applicant: QUALCOMM Incorporated, San Digeo, CA (US)

(72) Inventor: Haijun Zhao, Beijing (CN)

(21) Appl. No.: 14/631,518

(22) Filed: Feb. 25, 2015

(51) Int. Cl. G06F 3/0488; G06F 3/041

(52) U.S. Cl. CPC G06F 3/0488; G06F 3/0418

(57) ABSTRACT

Disclosed is a method and apparatus for authenticating a user based on a finger tap sequence on a touch screen. In one embodiment, the operations implemented may include: detecting a plurality of finger taps on a touch screen; measuring tap features for each of the finger taps to create a tap feature vector input including a finger identity (ID) and motion sensor data; and authenticating access by comparing the tap feature vector input to a stored tap feature vector.

### BACKGROUND

1. Field

Embodiments relate generally to user authentication. In particular, embodiments relate to methods for authenticating a user based on a tap sequence performed on a touch screen.

2. Relevant Background

The ability to authenticate a legitimate user to a computing device is vital in many applications. Selecting an authentication method involves a tradeoff between security, usability, and cost. Conventional methods for authenticating a user include asking the user to enter a pre-set password or a pre-set personal identification number (PIN), or to draw a pre-set pattern on a touch screen with a finger or a stylus. These methods may be cumbersome to use in certain scenarios (e.g., when a user wishes to authenticate herself to a smart phone without taking the smart phone out of the pocket, or when a user is visually impaired), or may be impractical with certain devices, such as small wearable devices, etc. Another category of conventional authentication methods involve the use of biometrics. These methods include fingerprint-based authentication, iris recognition-based authentication, etc. Special hardware, such as a fingerprint scanner, or an iris scanner, is required to support these biometric authentication methods, which increases the cost of the devices.

### SUMMARY

Aspects of the invention may relate to a computing device to authenticate a user based on a tap sequence performed on a touch screen. The computing device may comprise: a touch screen to receive a plurality of finger taps; and a processor configured to: detect a plurality of finger taps; measure tap features for each of the finger taps to create a tap feature vector input including a finger identity (ID) and motion sensor data; and authenticate access by comparing the tap feature vector input to a stored tap feature vector.

### BRIEF DESCRIPTION OF THE DRAWINGS

FIG. 1 illustrates an embodiment of a computing device where aspects of the invention may be practiced.

FIG. 2 illustrates an exemplary mobile device in which embodiments may be practiced.

FIG. 3 is a flowchart illustrating a method for tap sequence enrollment.

FIG. 4 is an illustration of a tap sequence input.

FIG. 5 is an illustration of an exemplary tap feature vector.

FIG. 6 is a flowchart illustrating a method for authenticating a user based on a tap sequence.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the term “computing system or device” refers to any form of programmable computer device including but not limited to laptop and desktop computers, tablets, smartphones, televisions, home appliances, cellular telephones, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any data processing apparatus.

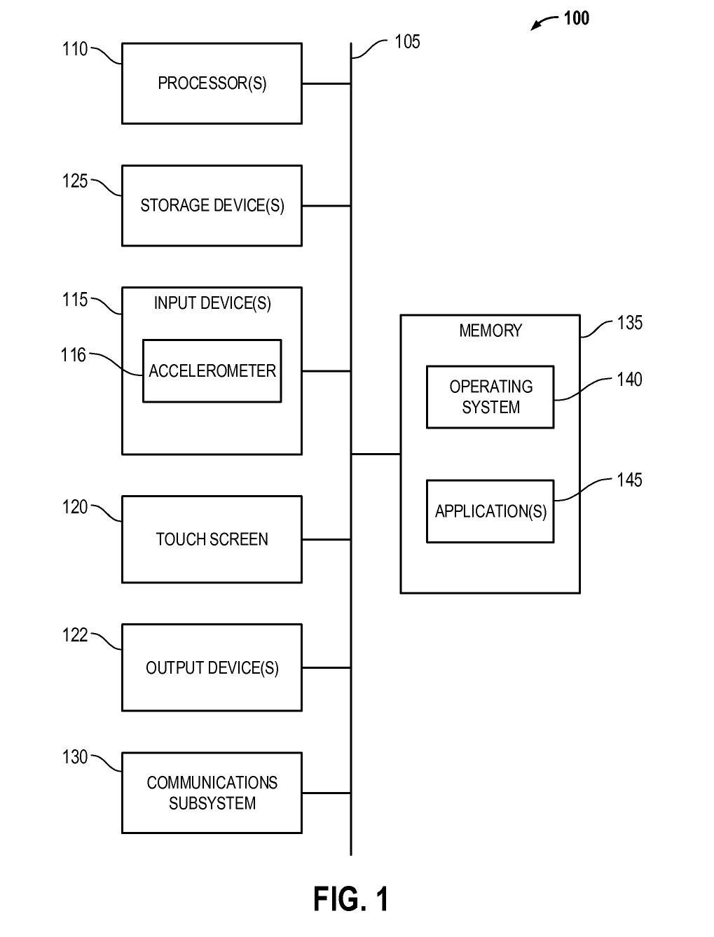

An example computing device 100 adapted for methods for user authentication based on a tap sequence is illustrated in FIG. 1. The computing device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input devices 115, which can include without limitation one or more sensors including an accelerometer 116, a mouse, a keyboard, keypad, gesture input device, microphone and/or the like; one or more output devices 122, which can include without limitation a display device, a speaker, a printer, and/or the like; and a touch screen 120 that can be used as both an input device for receiving touch inputs and an output device for displaying content.

The computing device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computing device 100 may also include a communication subsystem 130, which can include without limitation a modem, a network card (wireless or wired), an infrared communication device, a wireless communication device and/or chipset (such as a Bluetooth device, an 802.11 device, a Wi-Fi device, a WiMax device, cellular communication devices, etc.), and/or the like. The communications subsystem 130 may permit data to be exchanged with a network, other computing devices, and/or any other devices described herein. In one embodiment, the computing device 100 may further comprise a working memory 135, which can include a RAM or ROM device, as described above. It should be appreciated that computing device 100 may be a mobile device or a non-mobile device, and may have wireless and/or wired connections.

The computing device 100 may also comprise software elements, shown as being currently located within the working memory 135, including an operating system 140, device drivers, executable libraries, and/or other code, such as one or more application programs 145, which may comprise or may be designed to implement methods, and/or configure systems, provided by embodiments, as will be described herein. Merely by way of example, one or more procedures described with respect to the method(s) discussed below might be implemented as code and/or instructions executable by computing device 100 (and/or a processor 110 within computing device 100); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a computing device, such as the system 100. In other embodiments, the storage medium might be separate from a computing device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized computing device 100 and/or might take the form of source and/or installable code, which, upon compilation and/or installation on the computing device 100 (e.g., using any of a variety of generally available compilers, installation programs, compression/decompression utilities, etc.), then takes the form of executable code.

Embodiments may utilize machine learning techniques to extract features associated with finger taps on a touch screen 120 of computing device 100 based on a combination of touch screen data and accelerometer 116 sensor data. A finger tap refers to a simultaneous contact of one or more fingers of a user with the touch screen 120 of the device 100. With each tap, the associated touch screen data may comprise data relating to the size of the touch area(s), touch pressure, touch down time (e.g., duration of a registered touch operation), and touch interval time (e.g., time between neighboring registered touch operations), etc., and the associated accelerometer sensor data may comprise data relating to the physical movement of the device caused by the tap, such as the motion/acceleration in each of the x, y, z axes. The features may be extracted by applying machine learning techniques to the touch screen data and the accelerometer sensor data over a sliding window. Hereinafter the machine learning techniques used may include such techniques as k-Nearest Neighbors algorithm and support vector machine (SVM), etc. In some embodiments, a gyroscope may be used instead of or in combination with the accelerometer to provide data relating to the physical movement caused by the taps. Therefore, hereinafter a reference to accelerometer sensor data may also include a reference to gyroscope sensor data.

As different people may tap the touch screen in varying fashions, machine learning techniques may be utilized to determine probabilistically whether two sets of combined touch screen data and accelerometer sensor data result from tapping by the same user. Furthermore, based on reference tap points established by a calibration tap at the beginning of each enrollment tap sequence and authentication tap sequence, the number and identity (e.g., index, middle, ring, or little finger) of the fingers used in each tap may also be determined probabilistically. Therefore, a received tap sequence may be compared against an enrolled tap sequence using machine learning techniques, and the user is authenticated when the difference between the received tap sequence and the enrolled tap sequence is within a predetermined margin of error.

Therefore, as will be described in more detail hereinafter, as an example, computing device 100 may comprise: a touch screen 120 to receive a plurality of finger taps; and a processor 110 configured to: detect a plurality of finger taps; measure tap features for each of the finger taps to create a tap feature vector input including a finger identity (ID) and motion sensor data; and authenticate access by comparing the tap feature vector input to a stored tap feature vector. The tap features for each of the finger taps may include at least one of touch location, touch area, or touch pressure. Further, the tap features for each of the finger taps may further include at least one of touch down time or touch interval time. Additionally, by the use of accelerometer 116, tap features for each of the finger taps may include measured motion in the x, y, and z direction to create motion sensor data. Furthermore, processor 110 may further be configured to perform a calibration step to measure locations of detected finger taps to establish reference points. Moreover, processor 110 may further be configured to perform a registration process by: performing the calibration step; detecting a plurality of finger taps; measuring tap features for each of the finger taps to create a tap feature vector input; and storing the tap feature vector input.

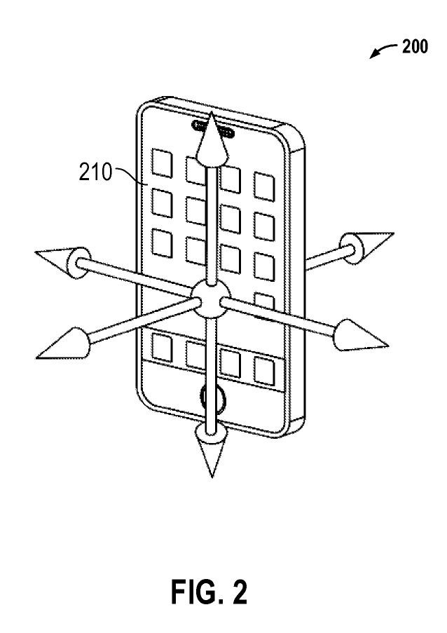

With additional reference to FIG. 2, an exemplary mobile device 200 in which embodiments may be practiced is shown. Mobile device 200 may correspond to device 100 of FIG. 1. As shown in FIG. 2, the mobile device 200 may include a touch screen 210 (corresponding to the touch screen 120 of FIG. 1) and an accelerometer (not shown) that can measure the acceleration of the device along x, y, and z axes.

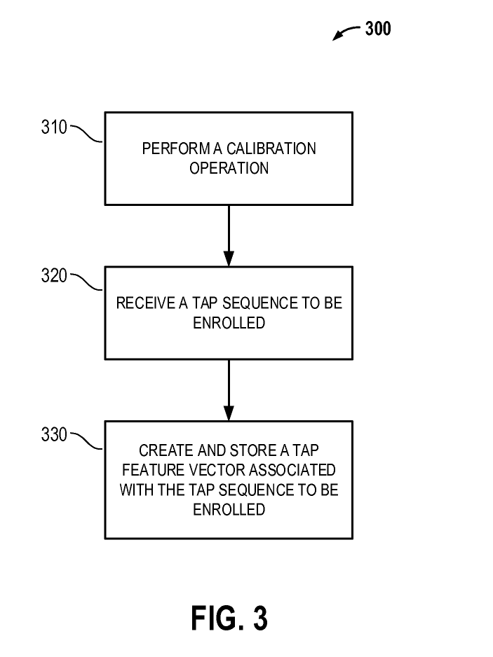

With additional reference to FIG. 3, a flowchart illustrating an exemplary method 300 for tap sequence enrollment is shown. The enrolled tap sequence may be matched against later-received tap sequences to authenticate a user. At block 310, a calibration operation may be performed. The user may tap the touch screen 120 of the device 100 with all the fingers of a same hand usable in the tap sequence. In one embodiment, these may include the index, middle, ring, and little fingers of one hand. The calibration operation establishes reference points that associate each finger with an approximate location on the touch screen 120. The reference points may be used to determine the identity of the fingers involved in a tap sequence.

At block 320, the tap sequence to be enrolled may be received. The user may perform the tap sequence to be enrolled by tapping the touch screen 120 a plurality of times. The user may perform each tap operation with one or more fingers, and the user is free to choose which finger(s) to use for each tap. The number of taps in the tap sequence may be chosen by the user (with or without a prescribed upper/lower bound), or may be predetermined. For example, in one embodiment, the tap sequence includes three taps. The user may choose to perform the first tap using the middle finger, to perform the second tap using the index, middle, and ring fingers, and to perform the third tap using the ring finger. Of course, it should be appreciated, that the user may select any type of finger tap sequence. Further, the user may decide to perform the tap sequence naturally, so that the tap sequence to be enrolled is representative of the natural way for the user to perform tap sequences.

At block 330, a tap feature vector associated with the tap sequence to be enrolled may be created and stored so that the tap sequence is enrolled. The tap feature vector may include information relating to tap features associated with the tap sequence and extracted from the touch screen data and the accelerometer sensor data using machine learning techniques. On a first level, the tap feature vector may be composed of the plurality of finger taps (Tap 1, Tap 2 . . . Tap N) in the tap sequence, and on a second level, each finger tap in the tap feature vector may be associated with the tap features extracted from the touch screen data and the accelerometer sensor data, which may include the identity of the fingers used for the tap, the touch down time, the touch interval time, the touch pressure, the size of the touch area, the accelerometer sensor data, and so on. Therefore, a tap feature vector includes information against which features associated with a later-received tap sequence may be compared to determine whether the enrolled tap sequence and a later-received tap sequence are similar.

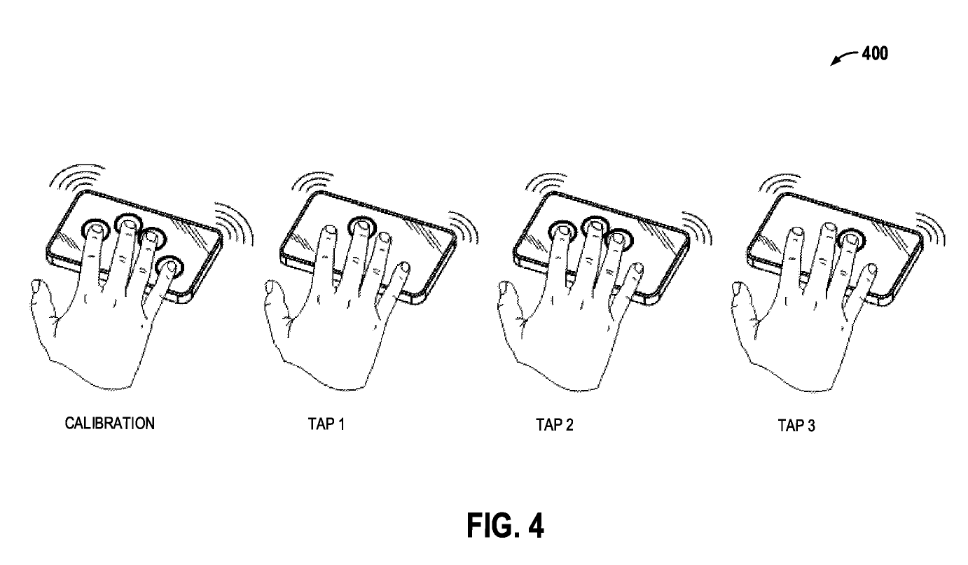

With additional reference to FIG. 4, an exemplary illustration 400 of an example tap sequence input is shown. The example tap sequence input in FIG. 4 may correspond to the process of tap sequence enrollment described above, or to the process of tap sequence authentication to be described below. In this example shown in FIG. 4, a user taps the touch screen 120 with index, middle, ring, and little fingers during the calibration operation, and then performs the first tap using the middle finger, performs the second tap using the index, middle, and ring fingers, and performs the third tap using the ring finger. Of course, this is only an example, and any type of tap sequence may be utilized.

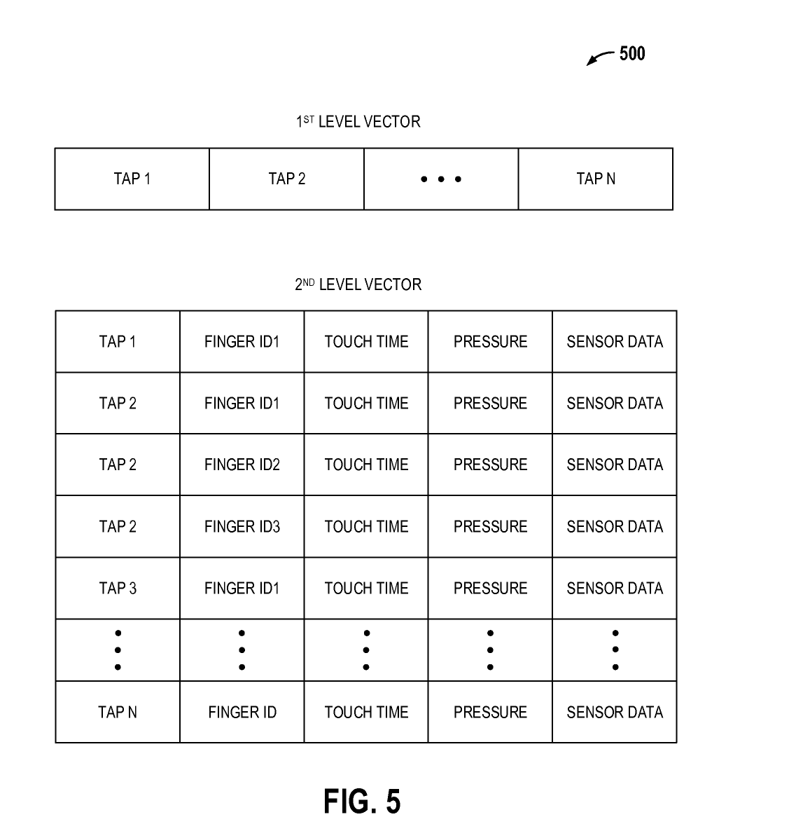

With additional reference to FIG. 5, an exemplary illustration of an example tap feature vector 500 is shown. As can be seen, on a first level, the tap feature vector may be composed of a plurality of taps (Tap 1, Tap 2 . . . Tap N) in the tap sequence, and on a second level, each tap in the tap feature vector may be associated with the features extracted from the touch screen data and the accelerometer sensor data (e.g., motion sensor data), which may include: the identity of the fingers used for the tap; the touch down time; the touch pressure; the accelerometer sensor data (e.g., motion sensor data), and so on. As an example, the taps (e.g., tap 1, tap 2, tap 2, tap 2, tap 3) of FIG. 5, correspond to the example tap sequence input of FIG. 4, for illustrative purposes. However, it should be appreciated that any type of tap sequence input may be utilized, and this is merely an illustration. Further, the features shown in FIG. 5 are not exhaustive, and additional features not shown, such as the touch interval time, the size of the touch areas, etc., may also be included. Therefore, an enrolled tap feature vector includes information against which tap features associated with a later-received tap sequence may be compared to determine whether the enrolled tap sequence and a later-received tap sequence are similar. Also, it should be appreciated that the finger identity (ID) may be associated with the touch location based upon the calibration.

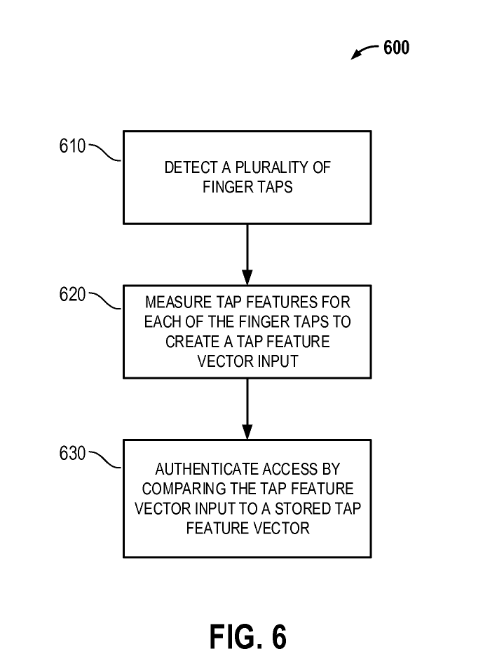

With additional reference to FIG. 6, a flowchart illustrating an exemplary method 600 for authenticating a user based on a tap sequence is shown. At block 610, a plurality of finger taps are detected. The user may perform a calibration operation to establish reference tap points that associate each finger with an approximate location on the touch screen 120 the same way the calibration operation is performed during the enrollment process, as described above, before the user performs the actual tap sequence used for authentication. At block 620, tap features for each of the finger taps may be measured to create a tap feature vector input including a finger identity (ID) and motion sensor data. Measuring the tap features may include extracting the features from the touch screen data and the accelerometer sensor data using machine learning techniques, as described above. The tap features may include at least one of touch location, touch area, touch pressure, touch down time, or touch interval time, etc. Furthermore, based on the accelerometer sensor data, the tap features may further include motion/acceleration in the x, y, and z directions (e.g., motion sensor data). At block 630, access may be authenticated by comparing the tap feature vector input to the stored enrollment tap feature vector. If the difference is below a predetermined margin of error, the access is authenticated.

In one embodiment, operations associated with tap feature extraction (for both enrollment and authentication) and tap feature vector matching may be executed in a trust zone, such as a Trusted Execution Environment (TEE). The enrolled tap feature vectors may also be stored in the trust zone.

Therefore, by utilizing the embodiments described herein, an access by a user may be authenticated based on a tap sequence. Tap features may be extracted from touch screen data and accelerometer sensor data using machine learning techniques. A tap feature vector input may be compared to one or more stored enrolled tap feature vectors, and the access is authenticated when the difference is within a predetermined margin of error. The methods for authentication described herein are secure, non-intrusive, and do not require special hardware support. The authentication is secure because it comprises three factors: 1) something only the legitimate user knows (e.g., the tap sequence), 2) something only the legitimate user has (e.g., the device), and 3) something only the legitimate user has (e.g., tap features that result from the user's natural touch behavior).

It should be appreciated that aspects of the invention previously described may be implemented in conjunction with the execution of instructions (e.g., applications) by processor 110 of computing device 100, as previously described. Particularly, circuitry of the device, including but not limited to processor, may operate under the control of an application, program, routine, or the execution of instructions to execute methods or processes in accordance with embodiments of the invention (e.g., the processes of FIGS. 3 and 6). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

The teachings herein may be incorporated into (e.g., implemented within or performed by) a variety of apparatuses (e.g., devices). For example, one or more aspects taught herein may be incorporated into a general computing device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device.

In some aspects a wireless device may comprise an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, LTE Advanced, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a touch screen to receive a plurality of finger taps; and
a processor configured to:
detect a plurality of finger taps;
measure tap features for each of the finger taps to create a tap feature vector input including a finger identity (ID) and motion sensor data; and
authenticate access by comparing the tap feature vector input to a stored tap feature vector.

2. The computing device of claim 1, wherein, the tap features for each of the finger taps include at least one of touch location, touch area, or touch pressure.

3. The computing device of claim 2, wherein, the tap features for each of the finger taps further include at least one of touch down time or touch interval time.

4. The computing device of claim 3, further comprising an accelerometer, wherein tap features for each of the finger taps further include motion in the x, y, and z direction measured by the accelerometer.

5. The computing device of claim 1, wherein the processor is further configured to perform a calibration step to measure locations of detected finger taps to establish reference points.

6. The computing device of claim 5, wherein the processor is further configured to perform a registration process to: perform the calibration step; detect a plurality of finger taps; measure tap features for each of the finger taps to create a tap feature vector input; and store the tap feature vector input.

7. The computing device of claim 1, further comprising a trust zone, wherein authenticating access by comparing the tap feature vector input to a stored tap feature vector, occurs in the trust zone.

8. A method for authenticating a user based on finger taps, comprising:
detecting a plurality of finger taps on a touch screen;
measuring tap features for each of the finger taps to create a tap feature vector input including a finger identity (ID) and motion sensor data; and
authenticating access by comparing the tap feature vector input to a stored tap feature vector.

9. The method of claim 8, wherein, the tap features for each of the finger taps include at least one of touch location, touch area, or touch pressure.

10. The method of claim 9, wherein, the tap features for each of the finger taps further include at least one of touch down time or touch interval time.

11. The method of claim 10, wherein, tap features for each of the finger taps further include motion in the x, y, and z direction measured by an accelerometer.

12. The method of claim 8, further comprising performing a calibration step to measure locations of detected finger taps to establish reference points.

13. The method of claim 12, further comprising performing a registration process to: perform the calibration step; detect a plurality of finger taps; measure tap features for each of the finger taps to create a tap feature vector input; and store the tap feature vector input.

14. The method of claim 8, wherein authenticating access by comparing the tap feature vector input to a stored tap feature vector, occurs in a trust zone.

15. A computing device comprising:
means for detecting a plurality of finger taps;
means for measuring tap features for each of the finger taps to create a tap feature vector input including a finger identity (ID) and motion sensor data; and
means for authenticating access by comparing the tap feature vector input to a stored tap feature vector.

16. The computing device of claim 15, wherein, the tap features for each of the finger taps include at least one of touch location, touch area, or touch pressure.

17. The computing device of claim 16, wherein, the tap features for each of the finger taps further include at least one of touch down time or touch interval time.

18. The computing device of claim 17, wherein tap features for each of the finger taps further include motion in the x, y, and z direction measured by an accelerometer.

19. The computing device of claim 15, further comprising means for performing a calibration step to measure locations of detected finger taps to establish reference points.

20. The computing device of claim 19, further comprising means for performing a registration process to: perform the calibration step; detect a plurality of finger taps; measure tap features for each of the finger taps to create a tap feature vector input; and store the tap feature vector input.

21. The computing device of claim 15, wherein the means for authenticating access by comparing the tap feature vector input to a stored tap feature vector, occurs in a trust zone.

22. A non-transitory computer-readable medium comprising code which, when executed by a processor, causes the processor of a computing device to perform operations comprising:
detecting a plurality of finger taps on a touch screen;
measuring tap features for each of the finger taps to create a tap feature vector input including a finger identity (ID) and motion sensor data; and
authenticating access by comparing the tap feature vector input to a stored tap feature vector.

23. The non-transitory computer-readable medium of claim 22, wherein, the tap features for each of the finger taps include at least one of touch location, touch area, or touch pressure.

24. The non-transitory computer-readable medium of claim 23, wherein, the tap features for each of the finger taps further include at least one of touch down time or touch interval time.

25. The non-transitory computer-readable medium of claim 24, wherein, tap features for each of the finger taps further include motion in the x, y, and z direction measured by an accelerometer.

26. The non-transitory computer-readable medium of claim 22, further comprising code for performing a calibration step to measure locations of detected finger taps to establish reference points.

27. The non-transitory computer-readable medium of claim 26, further comprising code for performing a registration process to: perform the calibration step; detect a plurality of finger taps; measure tap features for each of the finger taps to create a tap feature vector input; and store the tap feature vector input.

28. The non-transitory computer-readable medium of claim 22, wherein authenticating access by comparing the tap feature vector input to a stored tap feature vector, occurs in a trust zone.
